(19) United States
(12) Patent Application Publication
(10) Pub. No.: US 2025/0385390 A1
(43) Pub. Date: Dec. 18, 2025

(54) BATTERY PACK

(71) Applicant: HONDA MOTOR CO., LTD., Tokyo (JP)

(72) Inventor: Keisuke YOMOGIZAWA, Tokyo (JP)

(73) Assignee: HONDA MOTOR CO., LTD., Tokyo (JP)

(21) Appl. No.: 19/231,605

(22) Filed: Jun. 9, 2025

(30) Foreign Application Priority Data
Jun. 14, 2024 (JP) 2024-096387

(51) Int. Cl. H01M 50/503; B60L 50/60; H01M 50/204; H01M 50/249; H01M 50/522

(52) U.S. Cl. CPC H01M 50/503; H01M 50/204; H01M 50/249; H01M 50/522; B60L 50/60; H01M 2220/20

(57) ABSTRACT

A battery pack includes: plural electrical devices at least one of which includes a cell stack in which plural battery cells are stacked; a bus bar which electrically connects the plural electrical devices; and a case which accommodates the plural electrical devices and the bus bar, the bus bar includes fastening portions provided at both ends of the bus bar and fastened respectively to terminals of the plural electrical devices, and a wide portion provided between the fastening portions and configured to have a width larger than a width of each of the fastening portions, and at least a part of the wide portion of the bus bar is disposed between adjacent ones of the plural electrical devices.

### CROSS-REFERENCE TO RELATED APPLICATION

This application is based on and claims priority under 35 USC 119 from Japanese Patent Application No. 2024-096387 filed on Jun. 14, 2024.

### TECHNICAL FIELD

The present invention relates to a battery pack.

### BACKGROUND ART

In recent years, researches and developments have been conducted on a secondary battery which contributes to improvement in energy efficiency in order to allow more people to have access to affordable, reliable, sustainable and advanced energy.

For example, Patent Literature 1 discloses a plurality of battery cells/modules mounted on a vehicle such as an electric automobile and electrically coupled by a bus bar.
Patent Literature 1: JP2018-514926A

### SUMMARY OF INVENTION

An allowable current of the bus bar as disclosed in Patent Literature 1 varies according to a material and a size. There is a demand for a technique that can avoid an increase in a size of a battery pack while ensuring a sufficient allowable current for the bus bar regardless of the material.

The present invention provides a battery pack that can ensure a sufficient allowable current for a bus bar regardless of a material thereof and achieve space saving.

An aspect of the present invention provides
a battery pack including:
a plurality of electrical devices at least one of which includes a cell stack in which a plurality of battery cells are stacked;
a bus bar which electrically connects the plurality of electrical devices; and
a case which accommodates the plurality of electrical devices and the bus bar, in which
the bus bar includes
   fastening portions provided at both ends and fastened to terminals of the plurality of electrical devices, and
   a wide portion provided between the fastening portions and configured to have a width larger than that of the fastening portions, and
at least a part of the wide portion of the bus bar is disposed between the adjacent electrical devices.

According to the present invention, since a cross-sectional area of the bus bar is increased by the wide portion, electrical conductivity of the bus bar is increased, and a sufficient allowable current can be ensured for the bus bar regardless of a material of the bus bar. Since a space between the adjacent electrical devices can be used for disposing the wide portion, space saving of the battery pack can be achieved.

### BRIEF DESCRIPTION OF DRAWINGS

FIG. 1 is a perspective view of a battery pack 20 according to an embodiment of the present invention.

FIG. 2 is a perspective view of the battery pack 20 in a state in which an upper cover 50 is removed.

FIG. 3 is a top view of the battery pack 20 in the state in which the upper cover 50 is removed.

FIG. 4 is a schematic view showing wiring between a first junction board 31 disposed on a front side and a second junction board 32 disposed on a rear side.

FIG. 5 is a schematic view showing wiring between a plurality of battery modules 21 and the second junction board 32 (dash-dot line).

FIG. 6 is an enlarged perspective view of a first bus bar 73.

FIG. 7 is an enlarged perspective view of the first bus bar 73 electrically connecting adjacent battery modules 21.

FIG. 8 is an enlarged perspective view of a second bus bar 74.

FIG. 9 is an enlarged perspective view of the second bus bar 74 electrically connecting adjacent battery modules 21.

FIG. 10 is an enlarged perspective view of a third bus bar 75.

FIG. 11 is an enlarged perspective view of the third bus bar 75 electrically connecting adjacent battery modules 21.

### DESCRIPTION OF EMBODIMENTS

Hereinafter, an embodiment of a battery pack of the present invention will be described with reference to the accompanying drawings. The drawings are viewed in directions of reference numerals. In addition, in the present description and the like, for the sake of simplicity and clarity of explanation, a front-rear direction, a left-right direction, and an upper-lower direction are described according to directions viewed from a driver of a vehicle on which the battery pack is mounted, and in the drawings, a front side of the vehicle is represented by Fr, a rear side is represented by Rr, a left side is represented by L, a right side is represented by R, an upper side is represented by U, and a lower side is represented by D.

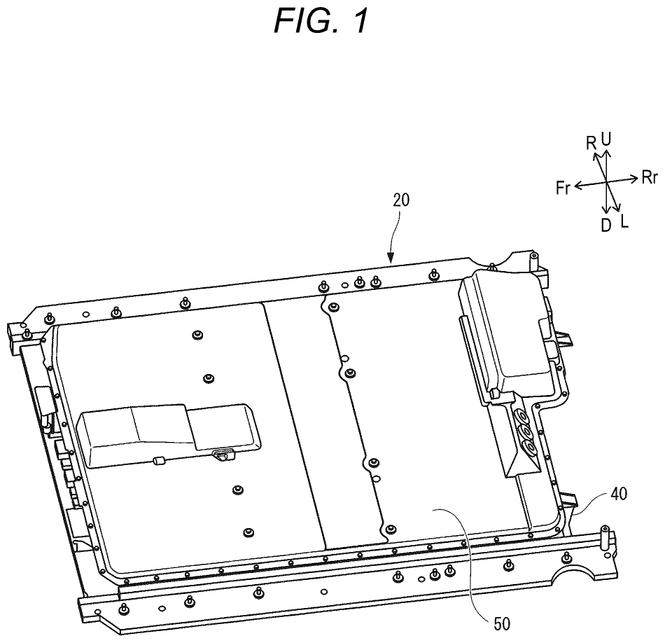

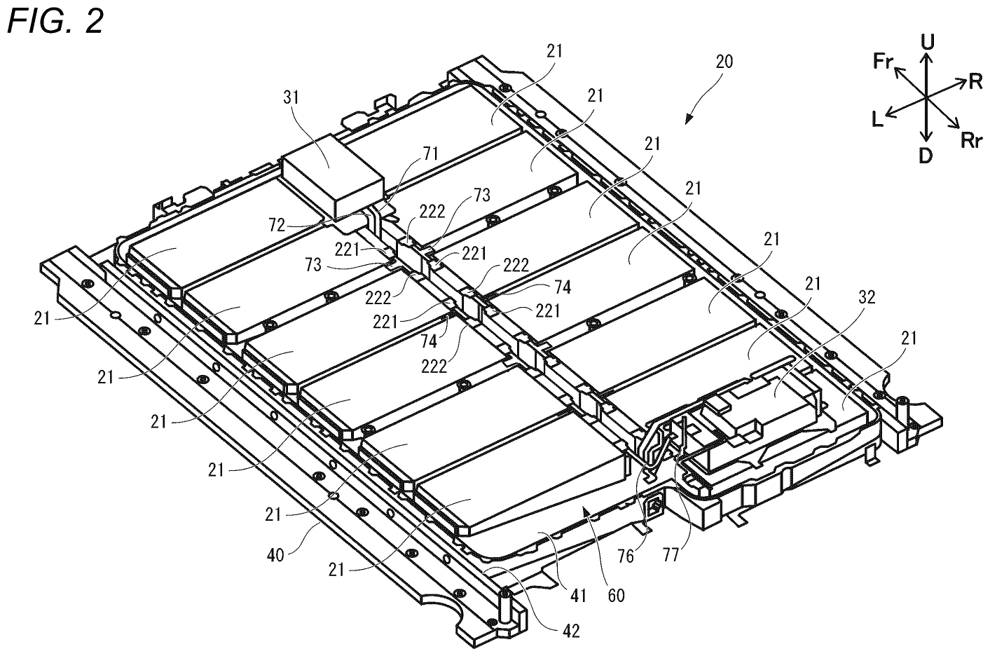

A battery pack 20 shown in FIGS. 1 to 3 is mounted under a floor of the vehicle such as an electric automobile. The battery pack 20 includes a lower case 40 whose upper portion is opened and an upper cover 50 that covers the upper portion of the lower case 40. An internal space 60 surrounded by the lower case 40 and the upper cover 50 is formed in the battery pack 20.

The lower case 40 includes a bottom plate portion 41 that covers lower portions of a plurality of battery modules 21, and left and right side wall portions 42 that stand upward and extend in the front-rear direction at both left and right ends of the bottom plate portion 41.

The battery pack 20 includes the plurality of battery modules 21, a first junction board 31, and a second junction board 32, which are accommodated in the internal space 60.

Each battery module 21 has a substantially rectangular parallelepiped shape. In each battery module 21, a plurality of battery cells are stacked. The plurality of battery cells in the battery module 21 are electrically connected by a bus bar plate (not shown) or the like. Each battery module 21 is an example of a “cell stack” in the present invention. A plus terminal 221 and a minus terminal 222, which are input and output terminals, are provided at an upper portion of each battery module 21. In the present embodiment, the plus terminal 221 and the minus terminal 222 are aligned in a short-side direction at the upper portion of each battery module 21 on one end on one side in a longitudinal direction when viewed in the upper-lower direction.

Each battery module 21 is disposed in the internal space 60 such that the longitudinal direction extends in a vehicle width direction and the short-side direction extends in the front-rear direction when viewed in the upper-lower direction. Further, each battery module 21 is disposed in the internal space 60 such that a side where the plus terminal 221 and the minus terminal 222 are provided in the longitudinal direction is a center side in the vehicle width direction.

The battery modules 21 are aligned in the front-rear direction in two rows in the left-right direction, and a total of thirteen battery modules 21 are disposed. Specifically, seven battery modules 21 are aligned in the front-rear direction in a right row, and six battery modules 21 are aligned in the front-rear direction in a left row.

The first junction board 31 is accommodated in the internal space 60 and is disposed in the vicinity of a front end of the battery pack 20. More specifically, in the internal space 60, the first junction board 31 is disposed above the battery modules 21 aligned foremost in the left-right direction to straddle the battery modules 21 aligned foremost in the left-right direction.

The second junction board 32 is accommodated in the internal space 60 and is disposed in the vicinity of a rear end of the battery pack 20. More specifically, in the internal space 60, the second junction board 32 is disposed above the battery module 21 disposed rearmost in the right row.

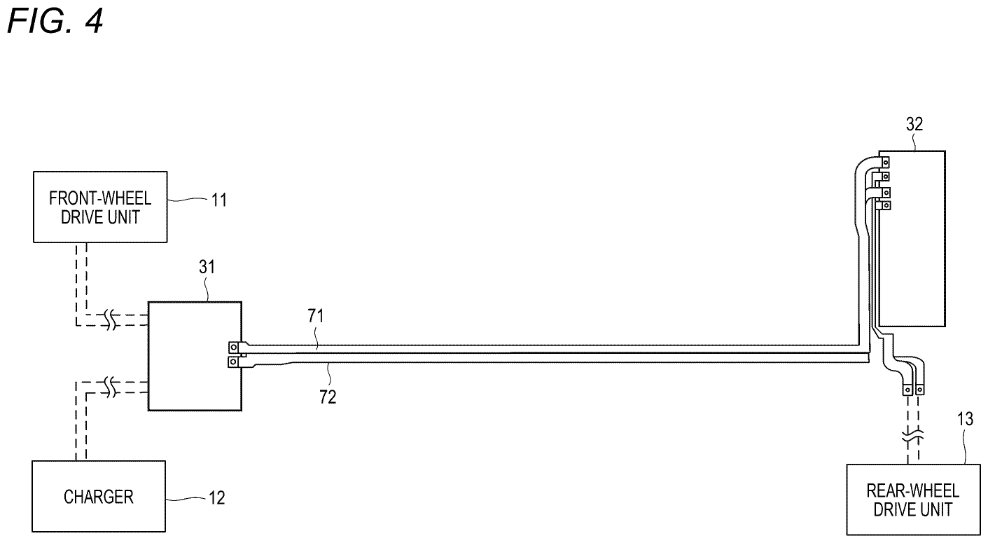

As shown in FIG. 4, high-voltage electric power lines 71 and 72 that connect the first junction board 31 to the second junction board 32 are routed in the internal space 60.

The first junction board 31 is electrically connected to a front-wheel drive unit 11 including a motor that drives front wheels and a charger 12 that receives electric power supplied from an external charger. The first junction board 31 is also electrically connected to an auxiliary device (an air conditioner heater or an air conditioner compressor), which is not shown. The first junction board 31 includes an electric power input and output circuit for the front-wheel drive unit 11, an electric power input and output circuit for the charger 12, and an electric power input and output circuit for the auxiliary device.

In addition to the first junction board 31, the second junction board 32 is electrically connected to the battery module 21 and a rear-wheel drive unit 13 including a motor that drives rear wheels. The second junction board 32 includes an electric power input and output circuit for the battery module 21 and an electric power input and output circuit for the rear-wheel drive unit 13. The second junction board 32 also includes a circuit breaker that is an electrical component for interrupting power supply to the battery pack 20 at the time of an abnormality.

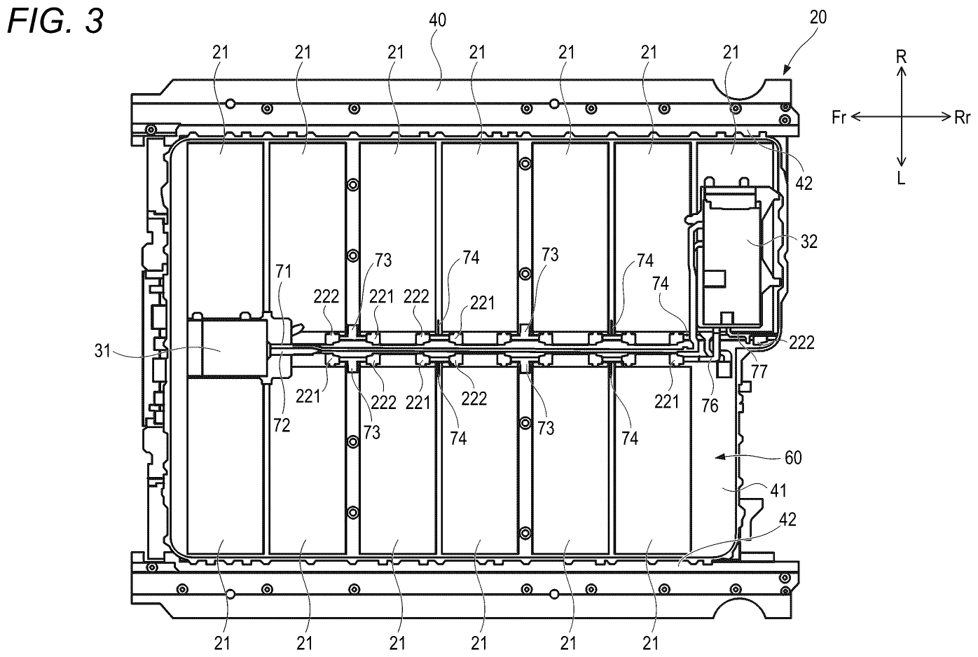

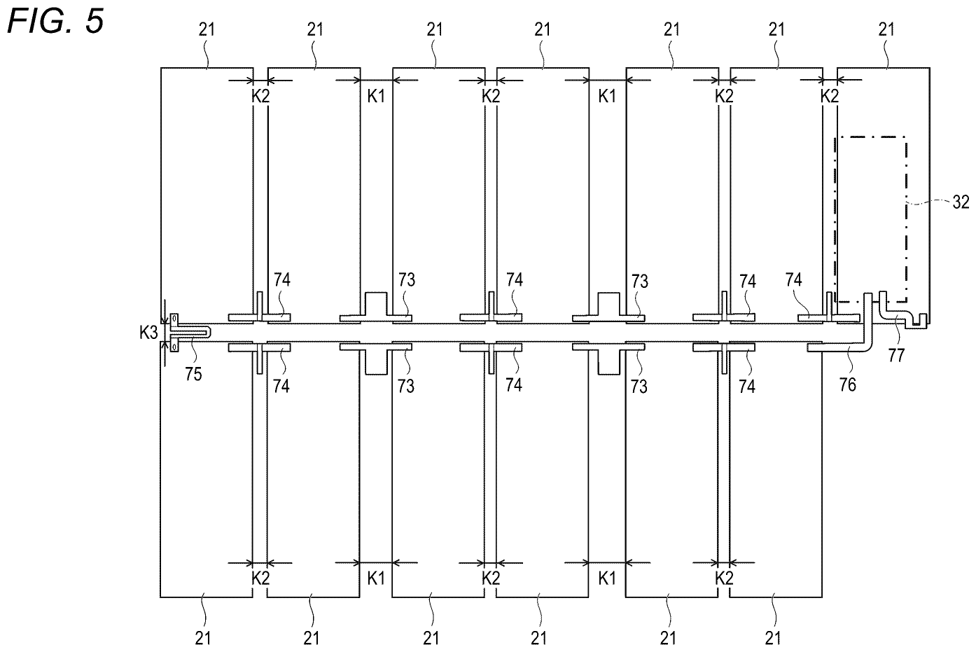

As shown in FIGS. 3 and 5, the battery pack 20 includes a plurality of first bus bars 73 and second bus bars 74 that electrically connect the minus terminals 222 of the battery modules 21 to the plus terminals 221 of the battery modules 21 adjacent in the front-rear direction. The battery modules 21 adjacent in the front-rear direction may be adjacent at an interval K1 or may be adjacent at an interval K2 narrower than the interval K1, the battery modules 21 adjacent at the interval K1 are electrically connected via the first bus bar 73, and the battery modules 21 adjacent at the interval K2 are electrically connected via the second bus bar 74. A plurality of cross members standing upward from the bottom plate portion 41 of the lower case 40 and extending in the left-right direction are provided at portions of the intervals K1 and K2.

The battery pack 20 further includes a third bus bar 75 that electrically connects the minus terminal 222 of one of the left and right battery modules 21 disposed foremost to the plus terminal 221 of the other of the left and right battery modules 21 disposed foremost. The two battery modules 21 disposed foremost are adjacent at an interval K3 (narrower than the interval K1) in the left-right direction. The battery modules 21 adjacent at the interval K3 are electrically connected via the third bus bar 75. In this way, in the present embodiment, the thirteen battery modules 21 are connected in series.

The battery pack 20 further includes, in the internal space 60, a plus-side bus bar 76 that electrically connects the second junction board 32 to the plus terminal 221 of the battery module 21 disposed rearmost in the left row, and a minus-side bus bar 77 that electrically connects the second junction board 32 to the minus terminal 222 of the battery module 21 disposed rearmost in the right row.

In this way, the second junction board 32 is electrically connected to the thirteen battery modules 21 connected in series.

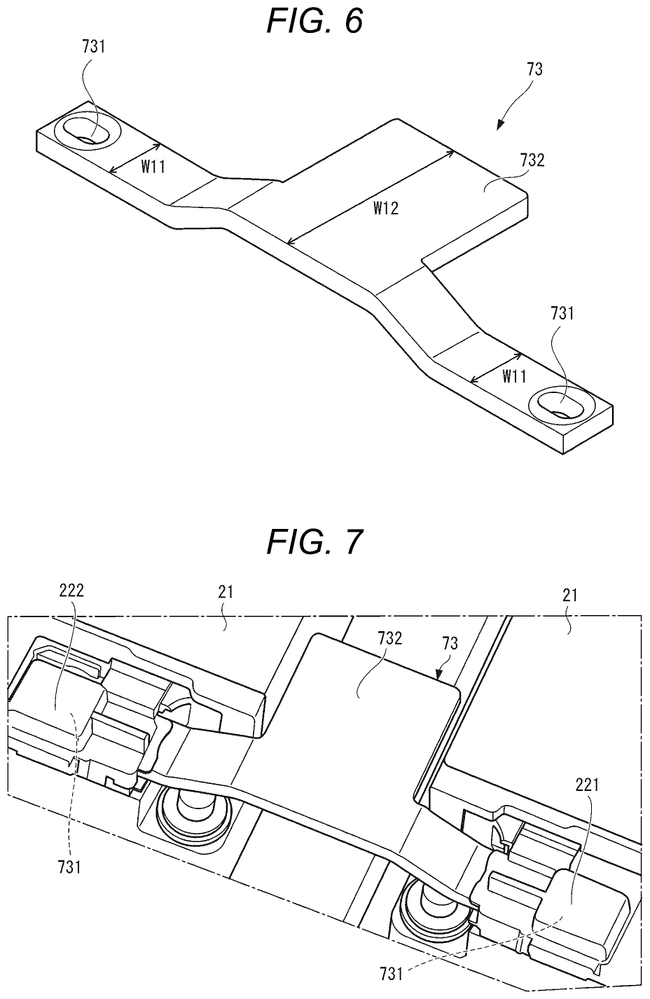

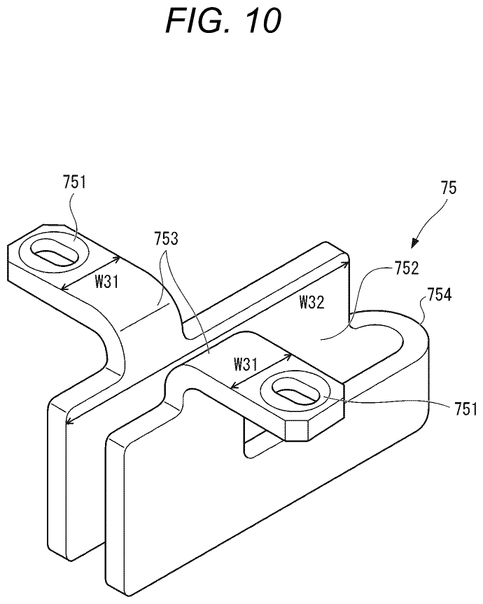

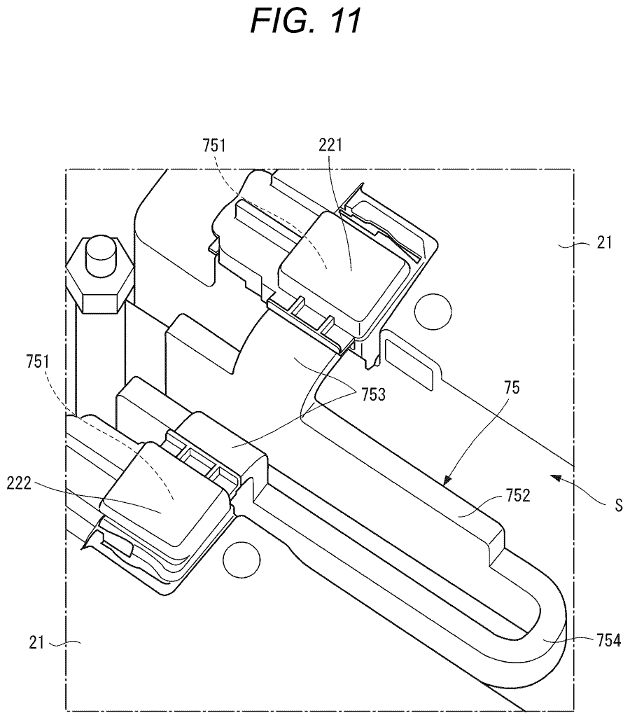

Next, details of the first to third bus bars 73, 74, and 75 will be described with reference to FIGS. 6 to 11. First, a configuration common to the first to third bus bars 73, 74, and 75 will be described.

The first to third bus bars 73, 74, and 75 respectively include a pair of fastening portions 731, 741, and 751 provided at both ends thereof and fastened to the terminals 221 and 222 of the adjacent battery modules 21, and wide portions 732, 742, and 752 respectively provided between the pair of fastening portions 731, 741, and 751 and configured such that widths W12, W22, and W32 are wider than widths W11, W21, and W31 of the fastening portions 731, 741, and 751, respectively. The fastening portions 731, 741, and 751 are fastened to the terminals 221 and 222 of the battery module 21 by, for example, bolts. Here, the term “width” refers to a length in a direction orthogonal to a direction in which the fastening portions 731, 741, and 751 extend. Thicknesses of the first to third bus bars 73, 74, and 75 are constant at the fastening portions 731, 741, and 751 and the wide portions 732, 742, and 752, respectively.

At least a part of the wide portions 732, 742, and 752 of the first to third bus bars 73, 74, and 75 is disposed between the adjacent battery modules 21. In the example shown in FIGS. 6 to 11, the entire wide portions 732, 742, and 752 are disposed between the adjacent battery modules 21.

According to such first to third bus bars 73, 74, and 75, since a cross-sectional area is increased by the wide portions 732, 742, and 752, electrical conductivity of the first to third bus bars 73, 74, and 75 is increased, and a sufficient allowable current can be ensured for the first to third bus bars 73, 74, and 75 regardless of a material of the first to third bus bars 73, 74, and 75. In addition, since a space between the adjacent battery modules 21 can be used for disposing the wide portions 732, 742, and 752, space saving can be achieved in the battery pack 20 even when the wide portions 732, 742, and 752 are provided. Further, since the cross-sectional area of the first to third bus bars 73, 74, and 75 is increased, for example, fastening stress due to bolt fastening generated at the fastening portions 731, 741, and 751 can be sufficiently received by the wide portions 732, 742, and 752.

Further, since a surface area of the first to third bus bars 73, 74, and 75 is increased by the wide portions 732, 742, and 752, heat dissipation is improved. In addition, since a shape obtained by providing the wide portions 732, 742, and 752 is distinctive, it is possible to prevent erroneous assembly of the first to third bus bars 73, 74, and 75.

It is preferable that the first to third bus bars 73, 74, and 75 do not include any welded portion. For example, the first to third bus bars 73, 74, and 75 are integrally formed by press-bending a metal plate material that is a single member. Since there is no welded portion, it is possible to prevent a decrease in electrical conductivity due to welding the first to third bus bars 73, 74, and 75, and to form the first to third bus bars 73, 74, and 75 with high strength.

The first to third bus bars 73, 74, and 75 are formed of a metal plate material made of aluminum, copper, or an alloy thereof. In particular, in order to reduce a weight, the first to third bus bars 73, 74, and 75 in the present embodiment are made of aluminum. Although aluminum has relatively low electrical conductivity as compared with copper, since the wide portions 732, 742, and 752 are provided at the first to third bus bars 73, 74, and 75, a sufficient allowable current can be ensured for the first to third bus bars 73, 74, and 75.

The widths W12, W22, and W32 of the wide portions 732, 742, and 752 of the first to third bus bars 73, 74, and 75 made of aluminum are designed based on a current value allowed when it is assumed that the bus bars electrically connecting the plurality of battery modules 21 are made of copper. Specifically, the widths W12, W22, and W32 of the wide portions 732, 742, and 752 are set such that the current value allowed for the first to third bus bars 73, 74, and 75 including the wide portions 732, 742, and 752 and made of aluminum is substantially equal to (or exceeds) a current value allowed for a copper bus bar having no wide portion. At this time, it is assumed that thicknesses of the first to third bus bars 73, 74, and 75 made of aluminum and the copper bus bar are equal. In this way, the widths W12, W22, and W32 can be appropriately designed.

It is desirable that the material for forming the first to third bus bars 73, 74, and 75 has material proof strength of 195 MPa or more and a fatigue limit of 70 MPa or more. The material proof strength is, for example, 0.2% proof strength, and is a stress value that causes 0.2% plastic strain upon unloading in a tensile test of a metal material having no clear yield point. The fatigue limit is a stress value at which no fatigue failure occurs even when the material is subjected to constant repeated stress. In this way, it is possible to provide sufficient proof stress and fatigue limit to the first to third bus bars 73, 74, and 75.

The widths W12, W22, and W32 of the wide portions 732, 742, and 752 are preferably set to such widths that the first to third bus bars 73, 74, and 75 do not resonate in response to a vehicle vibration. Accordingly, it is possible to prevent occurrence of loosening (specifically, loosening of bolt fastening) at the fastening portions 731, 741, and 751 due to resonance.

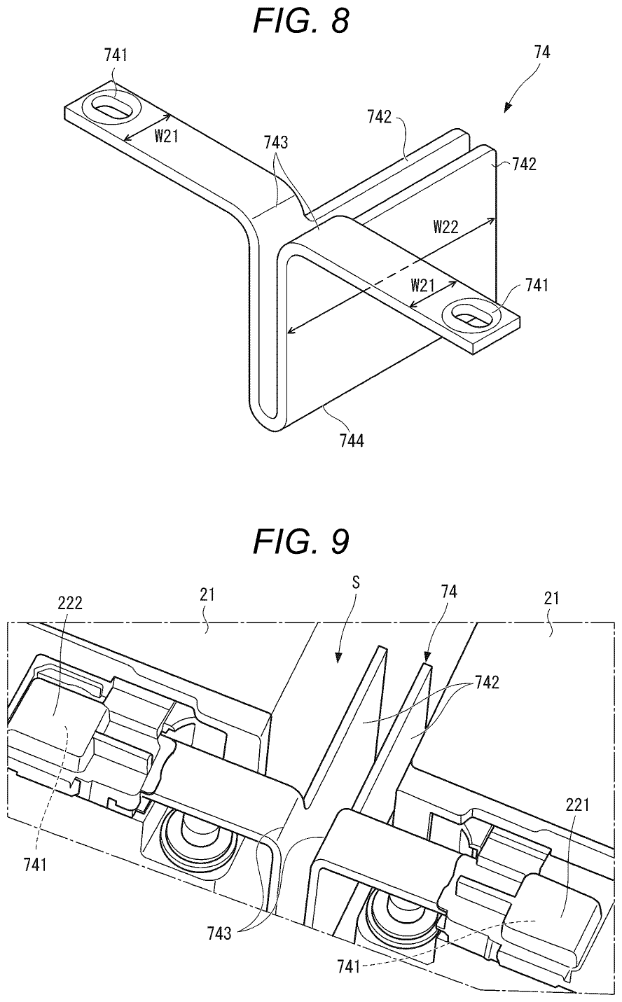

Next, the second and third bus bars 74 and 75 will be described with reference to FIGS. 8 to 11.

The second and third bus bars 74 and 75 further include bent portions 743 and 753 provided between the pair of fastening portions 741 and 751 and bent toward a space S interposed between outer surfaces (specifically, side surfaces) of the adjacent battery modules 21. The space S is a space corresponding to the interval K2 or the interval K3 between the adjacent battery modules 21 described above. At least a part of the wide portions 742 and 752 of the second and third bus bars 74 and 75 is disposed in the space S. In the example shown in FIGS. 8 to 11, the entire wide portions 742 and 752 are disposed in the space S.

Since the second and third bus bars 74 and 75 are bent and at least a part of the wide portions 742 and 752 is disposed in the space S interposed between the outer surfaces of the adjacent battery modules 21, space saving of the battery pack 20 can be achieved.

The second and third bus bars 74 and 75 include folded portions 744 and 754 that are folded in a substantially U-shape in the space S. According to such folded portions 744 and 754, the wide portions 742 and 752 are compactly accommodated in the space S, and space saving of the battery pack 20 can be further achieved. In addition, the folded portions 744 and 754 can sufficiently receive fastening stress generated at the fastening portions 731, 741, and 751 through elastic deformation.

The folded portion 744 of the second bus bar 74 is formed at the wide portion 742. Specifically, the folded portion 744 is formed by folding an intermediate portion of the wide portion 742. In this way, strength of the folded portion 744 can be improved.

Meanwhile, the folded portion 754 of the third bus bar 75 is formed at a position different from the wide portion 752. For example, the folded portion 754 of the third bus bar 75 is narrower than the wide portion 752 and is formed at one end of the wide portion 752 in a width direction. In this way, since the folded portion 754 is formed at the position different from the wide portion 752, the width of the folded portion 754 is set as desired, and the folded portion 754 is easily processed.

The bent portions 743 and 753 and the folded portions 744 and 754 of the second and third bus bars 74 and 75 are formed by bending a metal plate material. In this way, the bent portions 743 and 753 and the folded portions 744 and 754 can be easily processed.

Although an embodiment of the present invention has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

For example, in the above embodiment, the battery module 21 is shown as the example of the “cell stack”, but the “cell stack” is not limited thereto, and may be a plurality of battery cells stacked without being modularized.

In the above embodiment, the plurality of battery modules 21 are aligned in the front-rear direction in the two rows in the left-right direction in the internal space 60 of the battery pack 20, but the alignment can be set as desired. In addition, the number of the battery modules 21 accommodated in the internal space 60 is not limited to thirteen and can be set as desired.

In the above embodiment, the first to third bus bars 73, 74, and 75 electrically connect the battery modules 21 adjacent in the front-rear direction or the left-right direction, and may alternatively be configured to connect electrical devices (for example, the first junction board 31 or the second junction board 32) other than the battery modules 21.

In the present description, at least the following matters are described. Although corresponding constituent elements or the like in the embodiment described above are shown in parentheses, the present invention is not limited thereto.

(1) A battery pack (battery pack 20) including:
a plurality of electrical devices (battery module 21, first junction board 31, second junction board 32) at least one of which includes a cell stack (battery module 21) in which a plurality of battery cells are stacked;
a bus bar (first bus bar 73, second bus bar 74, third bus bar 75) which electrically connects the plurality of electrical devices; and
a case (lower case 40, upper cover 50) which accommodates the plurality of electrical devices and the bus bar, in which
the bus bar includes
   fastening portions (fastening portions 731, 741, 751) provided at both ends and fastened to terminals (plus terminal 221, minus terminal 222) of the plurality of electrical devices, and
   a wide portion (wide portions 732, 742, 752) provided between the fastening portions and configured to have a width larger than that of the fastening portions, and
at least a part of the wide portion of the bus bar is disposed between the adjacent electrical devices.

According to (1), since a cross-sectional area of the bus bar is increased by the wide portion, electrical conductivity of the bus bar is increased, and a sufficient allowable current can be ensured for the bus bar regardless of a material of the bus bar. Since a space between the adjacent electrical devices can be used for disposing the wide portion, space saving of the battery pack can be achieved even when the wide portion is provided. Further, since the cross-sectional area of the bus bar is increased, for example, stress generated at the fastening portions can be sufficiently received by the wide portion.

In (1), the electrical devices fastened to the bus bar by the fastening portions are not limited to the cell stack, and may be a device other than the cell stack.

(2) The battery pack according to (1), in which
the bus bar (second bus bar 74, third bus bar 75) further includes a bent portion (bent portion 743, 753) provided between the fastening portions and bent toward a space (space S) interposed between outer surfaces of the adjacent electrical devices, and
at least a part of the wide portion of the bus bar is disposed in the space.

According to (2), since the bus bar is bent and at least a part of the wide portion is disposed in the space interposed between the outer surfaces of the adjacent electrical devices, space saving of the battery pack can be achieved.

(3) The battery pack according to (2), in which
the bus bar (second bus bar 74) includes a folded portion (folded portion 744) folded into a substantially U-shape in the space, and
the folded portion is formed at the wide portion.

According to (3), since the folded portion is formed at the wide portion, strength of the folded portion can be improved.

(4) The battery pack according to (2), in which
the bus bar (third bus bar 75) includes a folded portion (folded portion 754) folded into a substantially U-shape in the space, and
the folded portion is formed at a position different from the wide portion.

According to (4), since the folded portion is formed at the position different from the wide portion, it is easy to process the folded portion.

(5) The battery pack according to any one of (2) to (4), in which
the bent portion of the bus bar is formed by bending.

According to (5), the bent portion can be easily processed.

(6) The battery pack according to any one of (1) to (5), in which
the bus bar does not include a welded portion.

According to (6), it is possible to prevent a decrease in electrical conductivity due to welding.

(7) The battery pack according to any one of (1) to (6), in which
the bus bar is made of aluminum, copper, or an alloy thereof.

According to (7), the bus bar can be made of aluminum, copper, or an alloy thereof.

(8) The battery pack according to (7), in which
the bus bar is made of aluminum.

According to (8), even when aluminum having relatively low electrical conductivity is used as the material of the bus bar, a sufficient allowable current can be ensured for the bus bar by the wide portion.

(9) The battery pack according to (8), in which
the width of the wide portion of the bus bar is designed based on a current value allowed when the bus bar electrically connecting the plurality of electrical devices is assumed to be made of copper.

According to (9), the bus bar can be designed to have an appropriate width.

(10) The battery pack according to any one of (1) to (9), in which
a material forming the bus bar has material proof strength of 195 MPa or more and a fatigue limit of 70 MPa or more.

According to (10), the bus bar can have sufficient proof stress and fatigue limit.

### REFERENCE SIGNS LIST

20 battery pack
21 battery module (cell stack, electrical device)
221 plus terminal (terminal)
222 minus terminal (terminal)
31 first junction board (electrical device)
32 second junction board (electrical device)
40 lower case (case)
50 upper cover (case)
73 first bus bar (bus bar)
731 fastening portion
732 wide portion
74 second bus bar (bus bar)
741 fastening portion
742 wide portion
743 bent portion
744 folded portion
75 third bus bar (bus bar)
751 fastening portion
752 wide portion
753 bent portion
754 folded portion

What is claimed is:

1. A battery pack comprising:
a plurality of electrical devices at least one of which includes a cell stack in which a plurality of battery cells are stacked;
a bus bar which electrically connects the plurality of electrical devices; and
a case which accommodates the plurality of electrical devices and the bus bar, wherein
the bus bar includes
fastening portions provided at both ends of the bus bar and fastened respectively to terminals of the plurality of electrical devices, and
a wide portion provided between the fastening portions and configured to have a width larger than a width of each of the fastening portions, and
at least a part of the wide portion of the bus bar is disposed between adjacent ones of the plurality of electrical devices.

2. The battery pack according to claim 1, wherein
the bus bar further includes a bent portion provided between the fastening portions and bent toward a space interposed between outer surfaces of the adjacent ones of the plurality of electrical devices, and
at least a part of the wide portion of the bus bar is disposed in the space.

3. The battery pack according to claim 2, wherein
the bus bar includes a folded portion folded into a substantially U-shape in the space, and
the folded portion is formed at the wide portion.

4. The battery pack according to claim 2, wherein
the bus bar includes a folded portion folded into a substantially U-shape in the space, and
the folded portion is formed at a position different from the wide portion.

5. The battery pack according to claim 2, wherein
the bent portion of the bus bar is formed by a bending process.

6. The battery pack according to claim 1, wherein
the bus bar does not include a welded portion.

7. The battery pack according to claim 2, wherein
the bus bar does not include a welded portion.

8. The battery pack according to claim 3, wherein
the bus bar does not include a welded portion.

9. The battery pack according to claim 4, wherein
the bus bar does not include a welded portion.

10. The battery pack according to claim 5, wherein
the bus bar does not include a welded portion.

11. The battery pack according to claim 1, wherein
the bus bar comprises aluminum, copper, or an alloy thereof.

12. The battery pack according to claim 2, wherein
the bus bar comprises aluminum, copper, or an alloy thereof.

13. The battery pack according to claim 3, wherein
the bus bar comprises aluminum, copper, or an alloy thereof.

14. The battery pack according to claim 4, wherein
the bus bar comprises aluminum, copper, or an alloy thereof.

15. The battery pack according to claim 5, wherein
the bus bar comprises aluminum, copper, or an alloy thereof.

16. The battery pack according to claim 11, wherein
the bus bar comprises aluminum.

17. The battery pack according to claim 16, wherein
the width of the wide portion of the bus bar is designed based on a current value allowed in a case where the bus bar electrically connecting the plurality of electrical devices is assumed to be made of copper.

18. The battery pack according to claim 1, wherein
a material forming the bus bar has material proof strength of 195 MPa or more and a fatigue limit of 70 MPa or more.

19. The battery pack according to claim 2, wherein
a material forming the bus bar has material proof strength of 195 MPa or more and a fatigue limit of 70 MPa or more.

20. The battery pack according to claim 3, wherein
a material forming the bus bar has material proof strength of 195 MPa or more and a fatigue limit of 70 MPa or more.
